(19) United States
(12) Patent Application Publication
(10) Pub. No.: US 2025/0244645 A1
(43) Pub. Date: Jul. 31, 2025

(54) PROJECTION DEVICE

(71) Applicant: Shenzhen Feichang Huapin Technology Co., Ltd., Shenzhen (CN)

(72) Inventors: Ronghua ZHUANG, Shenzhen (CN); Hengfei ZHANG, Shenzhen (CN)

(21) Appl. No.: 18/789,187

(22) Filed: Jul. 30, 2024

(30) Foreign Application Priority Data
Jan. 29, 2024 (CN) 2024202115333
Jan. 29, 2024 (CN) 2024202256628

(51) Int. Cl. G03B 21/14; G03B 31/00

(52) U.S. Cl. CPC G03B 21/145; G03B 31/00

(57) ABSTRACT

The present application relates to the technical field of projection devices, and in particular to a projection device comprising a base, a support bracket, and a projector body connected in sequence, wherein the projector body comprises a housing assembly, and the housing assembly is provided at an outer surface with a storage groove that accommodates and is adapted to the support bracket, and the support bracket is rotatably connected to the projector body within the storage groove. The rotatable connection between the support bracket and the projector body can realize the storage and the protection of the projector body, and the storage groove provided on the outer surface of the housing assembly can completely store the support bracket, which allows the projection device to have further reduced space occupancy after being stored, thus enabling a simple overall storage structure and a good storage effect.

### TECHNICAL FIELD

The present application relates to the technical field of projection devices, and in particular to a projection device.

### BACKGROUND ART

The projection device is a device that can project images or videos onto a screen, and can be connected to computers, VCDs, DVDs, BDs, game consoles, DVs, and so on through different interfaces to play the corresponding video signals. With the iteration of technology at the current stage, the types and functions of projection devices are getting richer and richer, but on the basis of the enhancement of various functions, the volume of the projection device will gradually increase and need to be used with a bracket, which causes the overall storage to be cumbersome, and makes it less convenient for the projection device that has been completely stored to be unfolded for use again.

### SUMMARY

In order to overcome the deficiency of cumbersome storage of the existing projection device with a bracket, the present application provides a projection device.

The solution to the technical problem of the present application is to provide a projection device comprising a base, a support bracket, and a projector body connected in sequence, wherein the projector body comprises a housing assembly, and the housing assembly is provided at an outer surface with a storage groove that accommodates and is adapted to the support bracket, and the support bracket is rotatably connected to the projector body within the storage groove.

Compared with the prior art, the projection device of the present application has the following advantages.

In the projection device provided in the present application, the rotatable connection between the support bracket and the projector body can realize the folded storage and the protection of the projector body, and the storage groove provided on the outer surface of the housing assembly can store the support bracket, which allows the projection device to have further reduced space occupancy after being stored, thus enabling a simple overall storage structure and a good storage effect, and the support bracket being rotatably connected to the projector body within the storage groove realizes the storage of the support bracket within the storage groove on the one hand, and on the other hand, enables the support bracket that has been stored to shield the internal structure of the storage groove, thus resulting in a more aesthetic overall appearance; and when the projection device that has been stored is used again, it is only necessary to place the base on the platform and adjust the projection angle of the projector body to perform projection, thus enabling the use to also be more convenient compared to the projection device that is assembled and stored in a conventional manner.

### BRIEF DESCRIPTION OF THE DRAWINGS

In order to more clearly illustrate the technical solutions in the embodiments of the present application, the following will briefly introduce the accompanying drawings to be used in the description of the embodiments or the prior art, and it is obvious that the accompanying drawings in the following description are only some of the embodiments of the present application, and that for those of ordinary skill in the art, other accompanying drawings can be obtained based on these drawings without creative labor.

FIG. 1 is a three-dimensional schematic diagram I of a projection device of embodiments of the present application.

FIG. 2 is a three-dimensional schematic diagram of the projection device of embodiments of the present application when a projector body is unfolded.

FIG. 3 is an exploded diagram of a portion of the structure of the projection device of embodiments of the present application.

FIG. 4 is a three-dimensional schematic diagram of a portion of the structure of the projection device of embodiments of the present application.

FIG. 5 is a three-dimensional schematic diagram of a connecting portion and a rotating portion of the projection device of embodiments of the present application.

FIG. 6 is an exploded schematic diagram of a portion of the structure of the projection device of embodiments of the present application.

FIG. 7 is a three-dimensional schematic diagram II of the projection device of embodiments of the present application.

FIG. 8 is an exploded diagram of some parts of the projection device of embodiments of the present application.

### DETAILED DESCRIPTION OF EMBODIMENTS

In order to make the objectives, technical solutions and advantages of the present application clearer and more understandable, the present application is described in further detail hereinafter in combination with the accompanying drawings and embodiments. It should be understood that the specific embodiments described herein are merely used for explaining the present application, but not for limiting the present application.

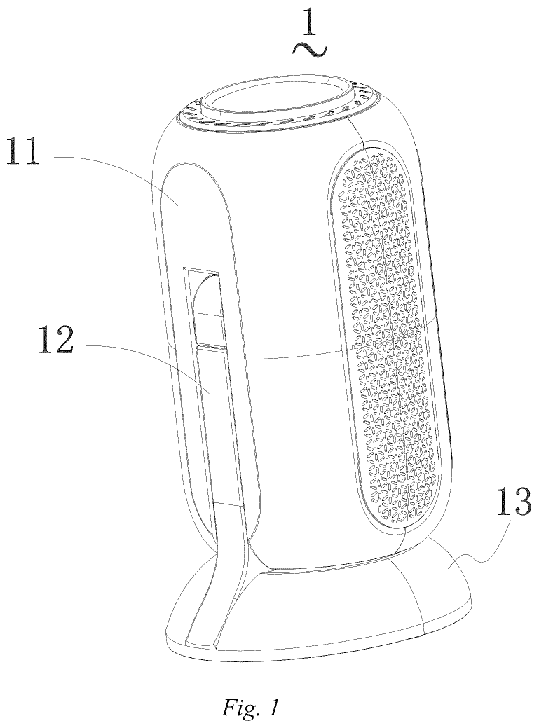

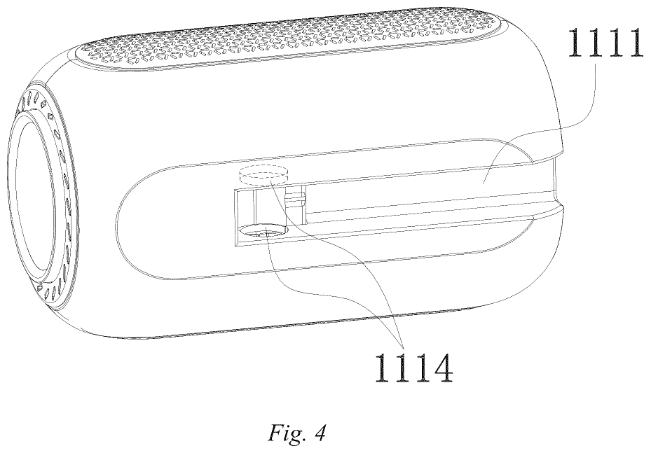

Embodiments of the present application provide a projection device 1, the specific structure of which is as shown in FIGS. 1-8. The projection device 1 comprises a base 13, a support bracket 12, and a projector body 11 connected in sequence, wherein the projector body 11 comprises a housing assembly 111, and the housing assembly 111 is provided at an outer surface with a storage groove 1111 that accommodates and is adapted to the support bracket 12, and the support bracket 12 is rotatably connected to the projector body 11 within the storage groove 1111.

The rotational connection between the support bracket 12 and the projector body 11 can realize the adjustment of the projection angle of the projector body 11, and the storage groove 1111 provided on the outer surface of the housing assembly 111 can completely store the support bracket 12, which allows the projection device 1 to have further reduced space occupancy after being stored, thus enabling a simple overall storage structure and a good storage effect. The support bracket 12 being rotatably connected to the projector body 11 within the storage groove 1111 realizes the storage of the support bracket 12 in the storage groove 1111 on the one hand, and on the other hand, enables the support bracket 12 that has been stored to shield the internal structure of the storage groove 1111, thus resulting in a more aesthetic overall appearance.

In some embodiments, the support bracket 12 is integrally or detachably connected to the base 13.

Optionally, the support bracket 12 and the base 13 are integrally molded in an integral structure, so that the overall structure has good mechanical properties and is easy to use.

Optionally, the support bracket 12 is detachably connected to the base 13, so that in special occasions, the support bracket 12 and the projector body 11 can be used individually as single entire units in conjunction with other structures, so as to make this projection device 1 applicable to more abundant scenes and have a wider scope of application.

Specifically, in a specific embodiment of the present application, at least part of one end of the support bracket 12 is integrally connected to the base 13 so as to increase the robustness of the connection.

More specifically, the support bracket 12 is provided at an outer periphery of the base 13.

In some embodiments, a rotation angle between the projector body 11 and the support bracket 12 is 0°-180°.

Specifically, the projector body 11 is in a stored state when the angle between the projector body 11 and the support bracket 12 is 0-15°.

The projector body 11 is in an unfolded state when the angle between the projector body 11 and the support bracket 12 is 15°-180°.

Optionally, when the angle between the projector body 11 and the support bracket 12 is 90°-180°, in order to avoid a blockage of the rotation of the support bracket 12 by the housing assembly 111, in this case, the storage groove 1111 is of a through-groove structure that penetrates through the housing assembly 111 to connect two end faces.

In a specific embodiment of the present application, the angle between the projector body 11 and the support bracket 12 is 0°-90°, that is, the storage groove 1111 is only provided at one end of the outer surface on the housing assembly 111. There is no limitation on the specific provision form of the storage groove 1111, which depends on the actual product.

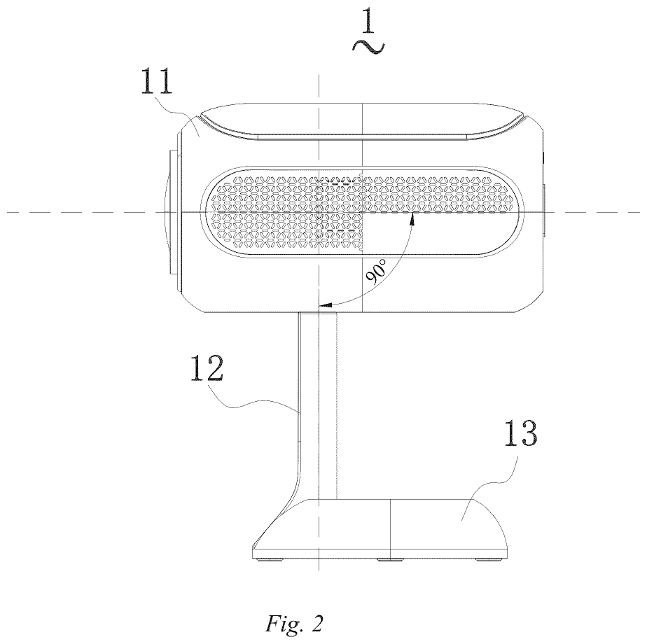

When the angle between the projector body 11 and the support bracket 12 is 90° (as shown in FIG. 2), that is, when the axial extension directions of the projector body 11 and the support bracket 12 are mutually perpendicular to each other, it is a common projection angle.

In some embodiments, as shown in conjunction with FIG. 2 and FIGS. 4-6, the support bracket 12 comprises a rotating portion 122 rotatably connected to an inner wall of the housing assembly 111 and a connecting portion 121 fixedly connected to the rotating portion 122, side walls of the storage groove 1111 are provided with two through holes 1114 at positions corresponding to the rotating portion 122 and two ends of the rotating portion 122 penetrate into the housing assembly 111 through the through holes 1114. Rotation of this rotating portion 122 enables rotational feedback of multi-stage adjustment of the projector body 11 and the support bracket 12 within a rotation range. When the rotating portion 122 is rotated relative to the projector body 11, the housing assembly 111 and the projector body 11 move in synchronization to achieve adjustment of the projection angle of the projector body 11. The multi-stage rotation realized by the mating of the rotating portion 122 with the housing assembly 111 can adjust the projector body 11 to any angle and keep it fixed, which makes it more convenient to use.

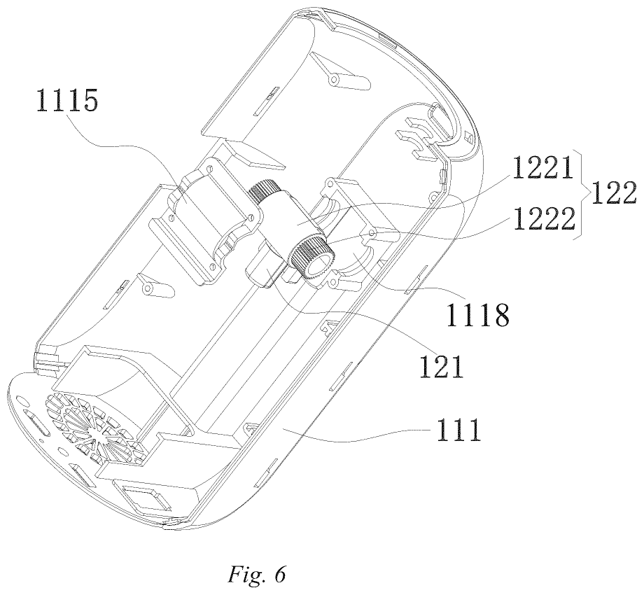

In some embodiments, the rotating portion 122 is limited to the inner wall of the housing assembly 111 by a limiting member 1115, and the limiting member 1115 and the wall body of the housing assembly 111 form a shaft hole 1118 (FIG. 6) therebetween that is adapted to the rotating portion 122, the rotating portion 122 mating with the housing assembly 111 by means of the shaft hole 1118 to effect limitation and rotation.

Specifically, in a specific embodiment of the present application, the rotating portion 122 comprises a smooth section 1221 and a gear section 1222 disposed at at least one end of the smooth section 1221, wherein the smooth section 1221 is adapted to the shaft hole 1118, and the smooth section 1221 and the gear section 1222 are coaxially disposed and are coaxially synchronized for movement.

The housing assembly 111 comprises the limiting member 1115 provided inside and abutting against two gear sections 1222, and when the rotating portion 122 is rotated inside the shaft hole 1118, the gear sections 1222 abut against or clamp the limiting member 1115 to drive the projector body 11 to rotate with the rotating portion 122.

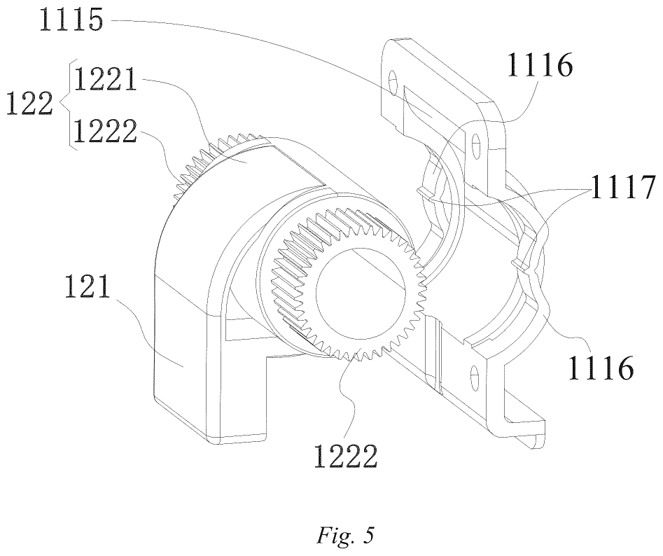

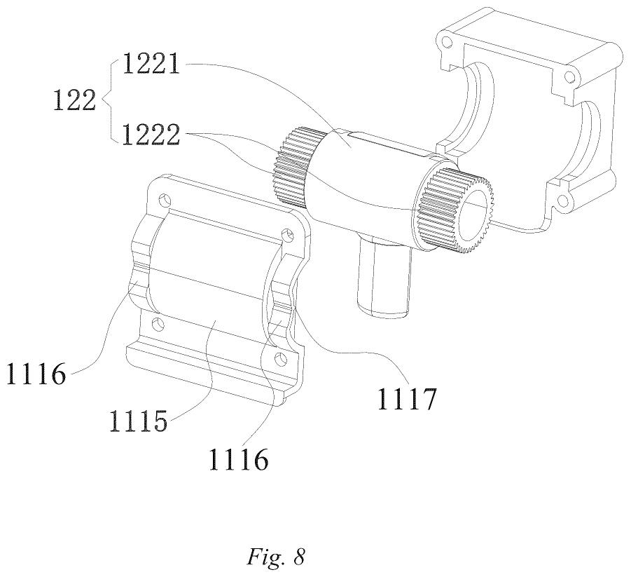

In some embodiments, as shown in conjunction with FIGS. 5 and 8, the limiting member 1115 is provided with a resilient member 1116 that is correspondingly meshed with the gear section 1222. The resilient member 1116 abuts against the gear section 1222, and the resilient member 1116 deforms as the resilient member 1116 moves relative to the gear section 1222. Specifically, there are two gear sections 1222 and they are provided at two ends of the smooth section 1221, respectively, the resilient member 1116 being in one-to-one correspondence with the gear sections 1222. The resilient member 1116 is provided with a locating tooth 1117 adapted to tooth seams of the gear section 1222. The gear section 1222 abuts against the locating tooth 1117 as the rotating portion 122 is rotated relative to the limiting member 1115, so as to drive the locating tooth 1117 to deform to move from one tooth seam into another tooth seam. As the gear section 1222 is rotated, since the locating tooth 1117 of the resilient member 1116 meshes with the gear section 1222, the resilient member 1116 periodically deforms and produces sound as the gear section 1222 is rotated, thereby enabling rotational feedback of multi-stage adjustment.

When the projector body 11 is rotated relative to the support bracket 12, the resilient member 1116 of the limiting member 1115 deforms and the locating tooth 1117 slides relative to the gear section 1222, thereby realizing the stage-by-stage rotation between the projector body 11 and the support bracket 12, and when the projector body 11 stops rotating, the locating tooth 1117 remains meshing and fixed with the gear section 1222 at a corresponding position to allow the relative angle of the projector body 11 at this time to be maintained.

In some embodiments, the support bracket 12 is a telescopic support bracket, a telescopic end of the support bracket 12 being integrally connected to the connecting portion 121 and the other end being disposed on the base 13, and the support bracket 12 is storable in the storage groove 1111 when completely retracted.

Specifically, the support bracket 12 comprises a telescopic multi-section telescopic rod, and two adjacent sections of the telescopic rod are fixed relative to each other when they are completely extended, so as to enable the multi-section telescopic rod to withstand the weight of the projector body 11 without retracting when it is in a stretched state.

More specifically, when the telescopic rod is completely retracted and stored in the storage groove 1111, the outer surface of the telescopic rod is in the same plane as the housing assembly 111, or the outer surface of the telescopic rod is concave with respect to the outer surface of the housing assembly 111, so as to provide post-storage protection of the telescopic rod through the housing assembly 111.

The telescopic design of the support bracket 12 can store a greater length with very low space occupancy to meet the user's projection needs, and the storage groove 1111 can store the completely retracted support bracket 12, thus further saving space and making it more convenient to carry and store the projection device 1.

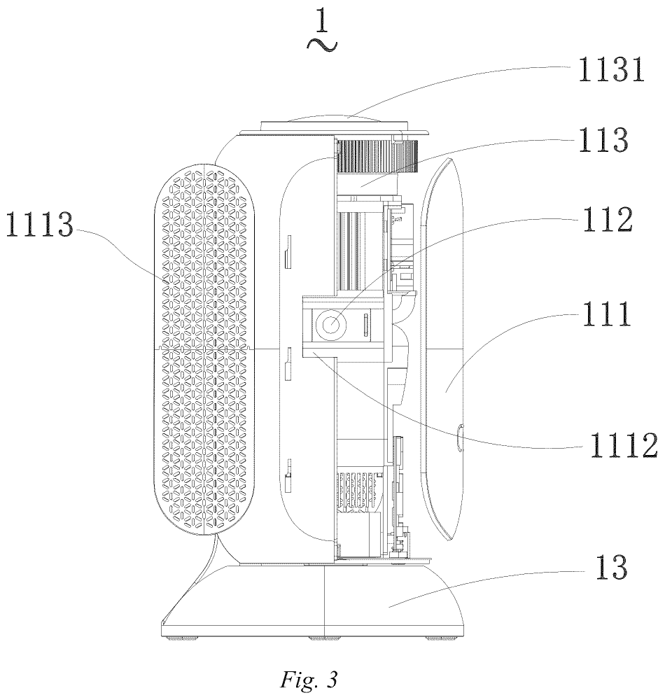

In some embodiments, as shown in conjunction with FIGS. 1 and 3, the projector body 11 comprises a sound playback assembly 112 disposed within the housing assembly 111, and the housing assembly 111 is provided with sound output holes 1112 in communication with the interior, with dust shields 1113 being provided at the sound output holes 1112, the sound playback assembly 112 outputting sound outwardly through the sound output holes 1112 and the dust shields 1113.

The sound output holes 1112 can enable the inner and outer sides of the housing assembly 111 to be in communication to play sound outwardly, and the dust shields 1113 protect the sound output holes 1112 and the internal structures without affecting the quality of sound outputting, and prevent mechanical collision of the objects while blocking impurities. The sound output holes 1112 can enable the inner and outer sides of the housing assembly 111 to be in communication to play sound outwardly, and the projector body 11 plays sound directionally through the sound output holes 1112 when in use, which in turn ensures the quality of sound outputting from the projection device 1 and brings a better viewing effect to the user.

Specifically, the sound output holes 1112 are symmetrically provided on the housing assembly 111, and the dust shields 1113 have a coverage area greater than or equal to the area of the sound output holes 1112.

In some embodiments, as shown in FIG. 3, the projector body 11 further comprises a projection assembly 113 disposed within the housing assembly 111, the projection assembly 113 comprising a projection lens 1131, wherein the projection lens 1131 is disposed in an axial extension direction of the projector body 11, and the projection lens 1131 or an end face away from the projection lens 1131 directly faces the base 13 when the projection device 1 is completely stored. The projection lens 1131 is provided on an end face so that the projection direction can be obtained intuitively by adjusting the pitch angle of the projector body 11, thereby making the adjustment easier. By storing the projection lens 1131 or an end face away from the projection lens 1131 to directly face the base 13, the base 13 and the housing assembly 11 are used to protect the components or apparatuses at that end face. At the same time, this further saves space and makes storage and carrying simple while enhancing the protection of the components and parts of the projection device, thereby increasing the service life.

Specifically, the end at which the projection lens 1131 is located is the projection end, and the end in the projection assembly 113 that is away from the projection lens 1131 is the operation end, wherein the operation end can be used for realizing control, charging, connecting to an external device, and heat dissipation functions of the projection device 1.

It is to be noted that in a specific embodiment of the present application, the support bracket 12 is provided at the outer periphery of the base 13, so that when the projection device 1 is folded for storage, one of the projection end or the operation end is aligned with the central region of the base 13, thereby realizing the protection of the base 13 for the components and parts at that end.

Either of the projection end and the operation end may face the base 13 directly during storage so as to achieve protection of the components at that end, which is not limited herein and is subject to practical requirements. In a specific embodiment of the present application, after the projection device 1 is stored, the operation end directly faces the base 13, thereby enhancing the protection of the operation end.

It is to be understood that the projection lens 1131 is provided on an end face so that the projector body 11 can be adjusted to a suitable projection direction by adjusting the pitch angle thereof when in use, thereby making the adjustment relatively easy.

By storing the projection lens 1131 or an end face away from the lens to directly face the base 13, the base 13 and the housing assembly 111 are used to protect the components or apparatuses at that end face. At the same time, this further saves space and makes storage and carrying simple while enhancing the protection of the components and parts of the projection device 1, thereby increasing the service life.

In some embodiments, when the projection device 1 is completely stored, the spacing between the end face of the projection end or of the operation end and the base 13 is 2-10 mm. By limiting the spacing between the projection lens or the end face away from the projection lens in the projector body 11 and the base, the base 13 can limit the degree of freedom of rotation of the projector body 11 in the stored state, thereby preventing the projector body 11, the support bracket 12, and the base 13 from unfolding due to an accident while in the stored state, thus realizing the protection of the projector body 11 and reducing the possibility of damage to the device by collision.

Optionally, the spacing between the projection end or the operation end and the base 13 may be 2 mm, 5 mm, 7 mm or 10 mm.

Specifically, in a specific embodiment of the present application, the spacing between the projection end or the operation end and the base 13 is 3 mm.

In addition, in order to prevent the projection end or the operation end from colliding with the base 13 during storage and causing damage to the projection device 1 itself, while performing the storage, it is necessary to first keep the telescopic rod at a certain height, then rotate the projector body 11 towards the support bracket 12, and finally lower the projector body 11 to the lowest level, thereby completing the storage.

It is to be understood that by limiting the spacing between the projection lens 1131 or the end face away from the projection lens 1131 in the projector body 11 and the base 13, the base 13 can limit the degree of freedom of rotation of the projector body 11 around the support bracket 12 in the completely stored state, thereby preventing the projector body 11 from unfolding on its own with respect to the support bracket 12 and the base 13 due to an external force when in the stored state, thus enhancing the protection of the projector body 11 and reducing the possibility of damage to the device by collision.

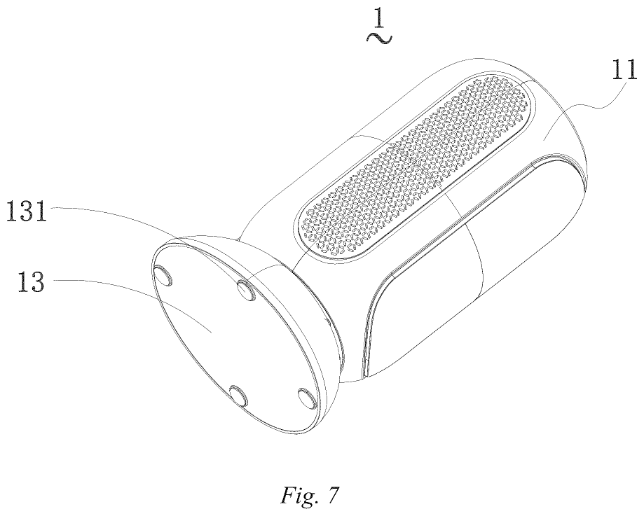

Further, referring to FIG. 7, a side of the base 13 away from the support bracket 12 is provided with fixing members 131 for fixing the base 13.

It should be noted that the fixing members 131 are provided between the base 13 and the carrying face, so the type, thickness and provision positions of the fixing members 131 will affect the horizontality of the projection device 1.

Specifically, in a specific embodiment of the present application, the fixing members 131 are symmetrically provided equal-height anti-slip pads.

It is to be understood that the fixing members 131 are used to make the connection between the base 13 and the carrying face tighter, thereby preventing slippage while ensuring the safety of the projection device 1 during use.

Specifically, as shown in conjunction with FIGS. 1, 2, and 4, after the use of the projection device 1, it is necessary to first rotate the projector body 11 in order to have the angle between the projector body 11 and the support bracket 12 to be 0-15°, and then retract the support rod in the support bracket 12 until the support bracket 12 is retracted to the shortest state, and then store it in the storage groove 1111, in which case, the projector body 11 is directly facing the middle part of the base 13, thus completing the storage process. The telescopic design of the support bracket 12 can store a greater length with very low space occupancy to meet the user's projection needs, and the storage groove 1111 can store the completely retracted support bracket 12, thus further saving space and making it more convenient to carry and store the projection device.

Specifically, when the projection device 1 is in the stored state and needs to be unfolded for use, the base 13 is placed on the platform, and the projector body 11 may first be raised and the telescopic rod in the support bracket 12 may be pulled out to move the projector body 11 away from the base 13, and after the telescopic rod has been stretched to a certain distance to ensure that the end face of the projector body 11 does not touch the base 13 during rotation, the projector body 11 may be rotated to a suitable angle to realize the process of unfolding the projection device 1 for use.

The embodiments described above are only the preferred embodiments of the present application and are not intended to limit the present application, and any modifications, equivalent substitutions and improvements made within the principles of the present application shall be included within the scope of protection of the present application.

1. A projection device comprising a base, a support bracket, and a projector body connected in sequence, wherein the projector body comprises a housing assembly, and the housing assembly is provided at an outer surface with a storage groove that accommodates and is adapted to the support bracket, and the support bracket is rotatably connected to the projector body within the storage groove.

2. The projection device of claim 1, wherein the support bracket is integrally or detachably connected to the base.

3. The projection device of claim 1, wherein a rotation angle between the projector body and the support bracket is 0°-180°, the projector body being in a stored state when the angle between the projector body and the support bracket is 0-15°; and the projector body being in an unfolded state when the angle between the projector body and the support bracket is 15°-180°.

4. The projection device of claim 3, wherein the support bracket is a telescopic support bracket, a telescopic end of the support bracket being integrally connected to the connecting portion and the other end being disposed on the base, and the support bracket is storable in the storage groove when completely retracted.

5. The projection device of claim 1, wherein the projector body comprises a sound playback assembly disposed within the housing assembly, and the housing assembly is provided with sound output holes in communication with the interior, the sound playback assembly outputting sound outwardly through the sound output holes.

6. The projection device of claim 5, wherein the sound output holes are symmetrically provided on the housing assembly, with dust shields being correspondingly provided at the sound output holes, the dust shields having a coverage area greater than or equal to the area of the sound output holes.

7. The projection device of claim 1, wherein the projector body further comprises a projection assembly disposed within the housing assembly, the projection assembly comprising a projection lens, wherein the projection lens is disposed in an axial extension direction of the projector body, and the projection lens or an end face away from the projection lens directly faces the base when the projection device is completely stored.

8. The projection device of claim 7, wherein the projection lens or the end face away from the projection lens has a spacing of 2-10 mm from the base when the projection device is completely stored.

9. The projection device of claim 1, wherein a side of the base away from the support bracket is provided with fixing members for fixing the base.

10. The projection device of claim 1, wherein the support bracket comprises a rotating portion rotatably connected to an inner wall of the housing assembly and a connecting portion fixedly connected to the rotating portion, side walls of the storage groove are provided with through holes at positions corresponding to the rotating portion and two ends of the rotating portion penetrate into the housing assembly through the through holes, and rotation of the rotating portion enables rotational feedback of multi-stage adjustment of the projector body and the support bracket within a rotation range.

11. The projection device of claim 10, wherein the rotating portion is limited to a wall body of the housing assembly by a limiting member, and the limiting member and the wall body of the housing assembly define a shaft hole therebetween that is adapted to the rotating portion, the rotating portion mating with the housing assembly by means of the shaft hole to effect limitation and rotation.

12. The projection device of claim 11, wherein the rotating portion comprises a smooth section and a gear section disposed at at least one end of the smooth section, wherein the smooth section and the gear section are coaxially disposed, the smooth section is adapted to the shaft hole, and the limiting member is provided with a resilient member that correspondingly meshes with the gear section, the resilient member abutting against the gear section, and the resilient member deforming as the resilient member moves relative to the gear section.

13. The projection device of claim 12, wherein the resilient member is provided with a locating tooth adapted to tooth seams of the gear section, the gear section abutting against the locating tooth as the rotating portion is rotated, so as to drive the locating tooth to deform to move from one tooth seam into another tooth seam.

14. The projection device of claim 13, wherein there are two said gear sections and they are provided at two ends of the smooth section, respectively, the resilient member being in one-to-one correspondence with the gear sections.
